(19) United States
(12) Patent Application Publication
(10) Pub. No.: US 2026/0220219 A1
(43) Pub. Date: Jul. 30, 2026

(54) ADAPTIVE FUNCTION LINKS FOR MODIFYING CONTENT ITEMS

(71) Applicant: Dropbox, Inc., San Francisco, CA (US)

(72) Inventor: Lawrence Ntim, Los Angeles, CA (US)

(21) Appl. No.: 18/925,999

(22) Filed: Oct. 24, 2024

(51) Int. Cl. G06F 16/958; G06F 40/40

(52) U.S. Cl. CPC G06F 16/958; G06F 40/40

(57) ABSTRACT

This disclosure describes systems that generate adaptive function links and cause the adaptive function links to generate modified versions of content items upon detecting an interaction with an adaptive function link. The disclosed systems can receive a request to generate a link for a content item. From the request, the disclosed systems can determine a computer function to embed within a link script of the adaptive function link. Upon an indication of an interaction with the adaptive function link, the disclosed systems can execute the computer function to automatically generate a modified version of the content item. For example, the disclosed systems can, responsive to detecting an interaction with the adaptive function link, generate a redacted version of a content item or a translated version of a content item.

### BACKGROUND

Advancements in computing devices and networking technology have given rise to a variety of innovations in cloud-based digital content storage and access. For example, digital content systems can provide access to, and synchronize changes for, digital content items across devices all over the world. Existing systems can also provide a suite of computer applications to accomplish a variety of tasks, such as organizing a digital calendar, generating and editing content items, initiating and attending video calls, and/or sending and receiving digital communications (e.g., text messages, emails, and instant messages). Indeed, existing digital content systems can generate and provide digital links (e.g., hyperlinks) to access digital content across diverse networking environments and over a variety of computing devices. Despite these capabilities, existing systems suffer from a variety of technical deficiencies, especially regarding operational flexibility and efficiency.

As mentioned briefly above, conventional systems suffer from a number of technical disadvantages or deficiencies with regard to generating and utilizing links for content items. For example, conventional systems are often operationally inflexible. For the most part, existing systems generate links that are singular in purpose—they are selectable to access a particular network location, either a website, a stored content item, or a particular location within a website or content item. Indeed, conventional systems are limited to rigidly generating static links solely to redirect devices to network locations.

In addition to being inflexible, conventional systems are also navigationally inefficient. Indeed, conventional systems often require excessive navigation through numerous device interactions to generate and provide access to modified content items. Using static links that only redirect, conventional systems require excessive numbers of interactions to modify a content item (e.g., by redacting or translating a document), store the modified version of the content item, and generate and share a link for the modified content item. Not only is it navigationally inefficient to require interactions at these multiple levels (sometimes in entirely separate applications or platforms), but processing the excessive interactions also consumes excessive computing resources that could otherwise be preserved with a more efficient system.

### SUMMARY

Embodiments of the present disclosure provide benefits and/or solve one or more of the foregoing or other problems in the art with systems, non-transitory computer-readable media, and methods for generating adaptive function links for modifying content items. For instance, the disclosed systems can receive requests to generate adaptive function links for content items. The disclosed systems can determine a computer function to execute upon selection of the link to modify the content item and can embed the computer function within an adaptive function link. Moreover, based on an interaction with the adaptive function link, the disclosed systems can execute the computer function to generate a modified version of the content item.

For example, the disclosed systems can generate an adaptive function link for redacted versions of content items. Indeed, the disclosed systems can generate a redacted version of a content item upon selection of an adaptive function link for the content item (e.g., according to its embedded function). In some embodiments, the disclosed systems can preemptively generate a plurality of redacted versions of the content item on upload of the content item. The disclosed systems can further generate an adaptive function link for the content item that embeds a function to identify (or generate) the appropriate redacted version for a user account selecting the link.

As another example of modifying content through an adaptive function link, in some embodiments, the disclosed systems can generate an adaptive function link for translated versions of content items. For example, the disclosed systems can generate, by implementing a function of the adaptive function link, a translated version of a content item upon selection of an adaptive function link for the content item. In some cases, the disclosed systems can preemptively generate a plurality of translated versions of a content item on upload of the content item. The disclosed systems can determine, according to an embedded function of the adaptive function link, which translated version to provide to a user account selecting the link.

Additional features and advantages of one or embodiments of the present disclosure are outlined in the description which follows, and in part will be obvious from the description, or may be learned by the practice of such example embodiments.

### BRIEF DESCRIPTION OF THE DRAWINGS

This disclosure will describe one or more example implementations of the systems and methods with additional specificity and detail by referencing the accompanying figures. The following paragraphs briefly describe those figures.

FIG. 1 illustrates an adaptive link system utilizing an adaptive function link to generate a modified version of a content item in accordance with one or more embodiments.

FIG. 2 illustrates an example overview of the adaptive link system utilizing a computer function embedded within an adaptive function link to generate a redacted version and/or a translated version of a content item in accordance with one or more embodiments.

FIGS. 3A-3B illustrate the adaptive link system utilizing parameters of client devices to create and/or update an adaptive function link in accordance with one or more embodiments.

FIG. 4 illustrates the adaptive link system generating a plurality of redacted versions of a content item according to various parameters of a client device in accordance with one or more embodiments.

FIG. 5 illustrates an example user interface to determine a redacted version of a plurality of redacted versions of a content item in accordance with one or more embodiments.

FIG. 6 illustrates the adaptive link system generating a plurality of translated versions of a content item according to various parameters of a client device in accordance with one or more embodiments.

FIGS. 7A-7C illustrate example user interfaces for a recipient client device and for a requestor client device for generating a translated version of a content item in accordance with one or more embodiments.

FIG. 8 illustrates a schematic diagram of an example environment of an adaptive link system in accordance with one or more embodiments.

FIG. 9 illustrates an example flowchart of a series of acts for utilizing an adaptive function link to generate a modified version of a content item in accordance with one or more embodiments.

FIG. 10 illustrates a block diagram of a computing device for implementing one or more embodiments.

FIG. 11 illustrates an example environment of a networking system having the adaptive link system in accordance with one or more embodiments.

### DETAILED DESCRIPTION

This disclosure describes one or more embodiments of an adaptive link system that can generate and utilize an adaptive function link to generate a modified version of a content item. For example, in one or more embodiments, the adaptive link system can embed a computer function in a link script defining an adaptive function link. The adaptive link system can embed the computer function as part of generating a selectable and shareable link for a content item. Indeed, the adaptive link system can determine, based on information provided as part of a request to generate the link, a computer function to include in the link script and/or how to apply the function to modify the content item. Accordingly, based on interaction with the adaptive function link, the adaptive link system can modify the content item according to a plurality of factors.

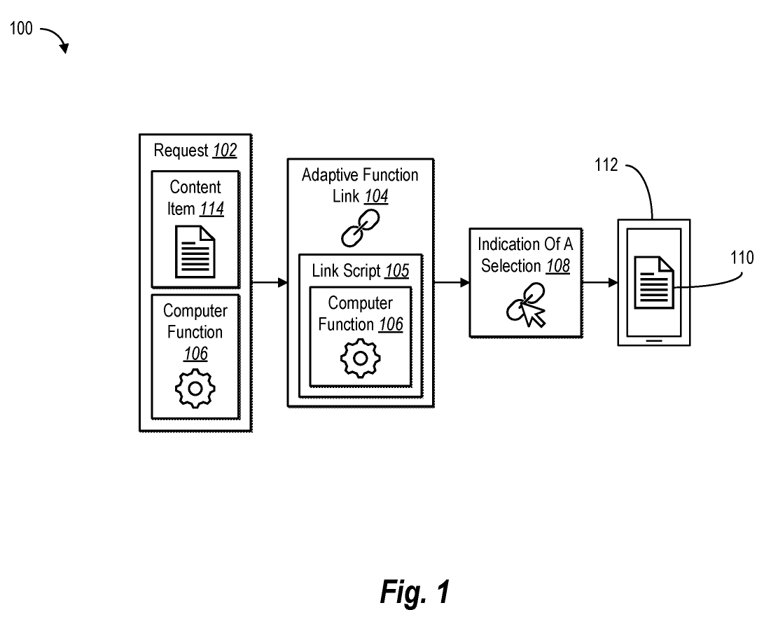

As just mentioned, the adaptive link system can generate an adaptive function link for a content item. In particular, the adaptive link system can embed a computing function into a link script of an adaptive function link and can execute the function upon selection of the link. FIG. 1 illustrates generating and utilizing an adaptive function link to generate a modified version of a content item in accordance with one or more embodiments.

As illustrated in FIG. 1, the adaptive link system 100 can receive a request 102 to generate a link for a content item 114. Specifically, the adaptive link system 100 can receive (from a client device) the request 102 that specifies a computer function 106 to execute based on (e.g., responsive to) a selection of the link. Moreover, the adaptive link system 100 can determine or define the computer function 106 (which, when executed, modifies the content item 114). For example, the adaptive link system 100 can determine that the request 102 defines the computer function to modify the content item 114 by redacting information (such as personal identifying information (PII), confidential information, protected health information (PHI) among others). Additionally or alternatively, the adaptive link system 100 can determine that the request 102 defines the computer function 106 to translate the content item 114 from a first language to a second language (or to multiple languages).

Responsive to receiving the request 102 (which includes the computer function 106 for the content item 114), the adaptive link system 100 can generate an adaptive function link 104. Specifically, the adaptive link system 100 can embed the computer function 106 in a link script 105 of the adaptive function link 104. Indeed, the adaptive link system 100 can generate the adaptive function link 104 such that, upon selection, the adaptive function link causes both navigation to the content item 114 (or a modified version) and performance or execution of the computer function 106 on the content item 114 (to generate a modified version).

The adaptive link system 100 can provide the adaptive function link 104 for display on a client device 112. Responsive to receiving an indication of a selection 108 (e.g., a click or a tap) of the adaptive function link 104, the adaptive link system 100 can perform the computer function 106 embedded in the link script to generate a modified version of the content item 110. Additionally, in response to receiving the indication of the selection 108 of the adaptive function link, the adaptive link system 100 can provide the modified version of the content item 110 for display on a client device 112.

For example, the adaptive link system can modify the content item 114 by performing a redaction function (e.g., a computer function that redacts information from a content item) on the content item 114. The adaptive link system 100 can determine a level of redaction to apply to the content item 114 according to metadata associated with the client device 112. Additionally or alternatively, the adaptive link system 100 can determine the level of redaction according to a clearance level associated with the client device 112. Moreover, in some embodiments, the adaptive link system 100 can generate a plurality of redacted versions of the content item by applying different levels of redaction to the content item, either upon link creation and/or upon link selection. In some cases, the adaptive link system 100 can provide a preview of each of the plurality of redacted versions of the content item in a graphical interface (e.g., a graphical user interface) of a client device, and receive an indication of which of the plurality of redacted content items to include in the adaptive function link 104.

Moreover, the adaptive link system 100 can modify the content item 114 by performing a translation function (e.g., a computer function that translates the content item from a first language to a second language) on the content item 114. The adaptive link system 100 can determine a translation language for the translated version of the content item according to metadata associated with the client device 112 (and/or a corresponding user account). Moreover, in some embodiments, the adaptive link system 100 can generate a plurality of translated versions of the content item, either upon link creation or link selection. In some cases, the adaptive link system 100 can provide a preview of each of each of the plurality of translated versions of the content item in a graphical interface (e.g., a graphical user interface) of a client device, and can receive an indication of which of the plurality of translated content items to include in the adaptive function link 104.

As suggested by the foregoing discussion, the adaptive link system 100 provides a variety of technical advantages relative to conventional systems. For example, the adaptive link system 100 can improve operational flexibility compared to conventional computing systems. Indeed, as illustrated in FIG. 1, the adaptive link system 100 can generate an adaptive function link that contains a computer function embedded in a link script that, when executed, will modify a content item. Indeed, the adaptive link system 100 redefines the concept of “links” as adaptive and dynamic rather than static, embedding scripts that call functions, large language models, and/or other models to modify content items.

In addition, embodiments of the adaptive link system 100 improve navigational efficiency over conventional systems. By creating an adaptive function link that modifies content items upon execution of one or more functions embedded in the adaptive function link, the adaptive link system 100 can significantly reduce the navigation required to generate a modified version of a content item. Indeed, rather than requiring navigation across several intermediary platforms to generate and share a modified version of a content item, the adaptive link system 100 can generate a single adaptive function link that can dynamically generate and provide access to modified versions of content items (e.g., based on a single click of the link).

As illustrated by the foregoing discussion, the present disclosure utilizes a variety of terms to describe features and benefits of the model modification system. Additional detail is hereafter provided regarding the meaning of these terms as used in this disclosure. As used herein, the term “content item” refers to a digital object or a digital file that includes information interpretable by a computing device (e.g., a client device) to present information to a user. A digital content item can include a file or a folder such as a digital text file, a digital image file, a digital audio file, a webpage, a website, a digital video file, a web file, a link, a digital document file, or some other type of file or digital object. A digital content item can have a particular file type or file format, which may differ for different types of digital content items (e.g., digital documents, digital images, digital videos, or digital audio files). In some cases, a digital content item can refer to a remotely stored (e.g., cloud-based) item or a link (e.g., a link or reference to a cloud-based item or a web-based content item) and/or a content clip that indicates (or links/references) a discrete selection or segmented sub-portion of content from a webpage or some other content item or source. A content item can also include application-specific content that is siloed to a particular computer application but is not necessarily accessible via a file system or via a network connection. A digital content item can be editable or otherwise modifiable and can also be sharable from one user account (or client device) to another. In some cases, a digital content item is modifiable by multiple user accounts (or client devices) simultaneously and/or at different times.

Along these lines, the term “modified version of the content item” (sometimes referred to as “modified content item”) refers to a content item with one or more modified characteristics. For example, a modified version of a content item can be a translated version of the content item (e.g., a new version of the content item wherein at least some of the content of the content item has been translated from a first language to a second language), a redacted version of the content item (e.g., a new version of a content item wherein at least some information of the content item has been removed and/or otherwise modified), an encrypted version of the content item, a compressed version of the content item, a textual extraction of the content item, a filtered version of the content item, a captioned version of the content item, or a blurred version of the content item, among others.

In addition, the term “large language model” refers to a set of one or more machine learning models trained to perform computer tasks to generate or identify computing code and/or data in response to trigger events (e.g., user interactions, such as text queries and button selections). In particular, a large language model can be a neural network (e.g., a deep neural network) with many parameters trained on large quantities of data (e.g., unlabeled text) using a particular learning technique (e.g., self-supervised learning). For example, a large language model can include parameters trained to generate or identify computing code and/or data based on various contextual data, including information from historical user account behavior.

Relatedly, as used herein, the term “machine learning model” refers to a computer algorithm or a collection of computer algorithms that automatically improve for a particular task through iterative outputs or predictions based on use of data. For example, a machine learning model can utilize one or more learning techniques to improve in accuracy and/or effectiveness. Example machine learning models include various types of neural networks, decision trees, support vector machines, linear regression models, and Bayesian networks. In some embodiments, the model modification system utilizes a large language machine learning model in the form of a neural network.

Along these lines, the term “neural network” refers to a machine learning model that can be trained and/or tuned based on inputs to determine classifications, scores, or approximate unknown functions. For example, a neural network includes a model of interconnected artificial neurons (e.g., organized in layers) that communicate and learn to approximate complex functions and generate outputs (e.g., modified content items) based on a plurality of inputs provided to the neural network. In some cases, a neural network refers to an algorithm (or a set of algorithms) that implements deep learning techniques to model high-level abstractions in data. A neural network can include various layers such as an input layer, one or more hidden layers, and an output layer that each perform tasks for processing data. For example, a neural network can include a deep neural network a convolutional neural network, a recurrent neural network (e.g., an LSTM), a graph neural network, a large language model, or a generative neural network.

Additionally, as used herein, the term “adaptive function link” refers to a dynamic link to a content item which defines a link script that includes an embedded function for modifying the content item. An adaptive function link can both enable a user account to navigate to a virtual location of a content item as well as perform a computer function to modify the content item. As noted, the adaptive function link can include a link script. As used herein, the term “link script” includes or refers to a functional component, such as executable computer code, of the adaptive function link that the adaptive link system executes responsive to detecting an interaction with the adaptive function link. For example, responsive to an interaction with the adaptive function link, the adaptive link system 100 can interpret the link script to execute a computer function, such as redacting a portion of a content item, translating a content item (or a portion of a content item), triggering an event, or manipulating a webpage associated with the content item.

Along these lines, as used herein, the term “computer function” refers to a function, process, or subroutine executable by a processor. For example, a computer function can be called or instantiated by an adaptive function link and can be executable to perform a modification on a content item. A computer function call or apply a large language model, a machine learning model, a neural network, an open-source library, application program interfaces (APIs), web browser modification plugins, cloud-based modification services (e.g., cloud-hosted modification platforms), embedded modification widgets, mobile applications, among others. Similarly, a “redaction function” can be a computer function that modifies the content item by redacting information from the content item. Moreover, a “translation function” can be a computer function that modifies the content item by translating the content item.

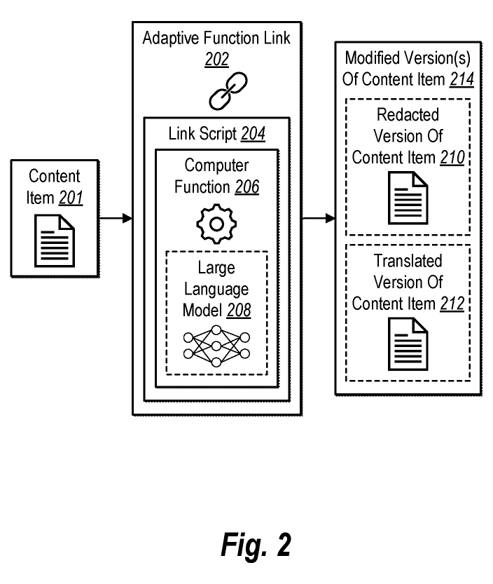

As previously mentioned, in some embodiments, the adaptive link system 100 can utilize a large language model to perform a computer function to generate a modified version of a content item. In particular, the adaptive link system 100 can embed a large language model script into an adaptive function link such that, upon selection, the adaptive link system 100 utilizes the large language model to modify the linked content item. FIG. 2 illustrates an example diagram of utilizing a large language model embedded in an adaptive function link to generate modified versions of the content item in accordance with one or more embodiments.

As shown in FIG. 2, the adaptive link system 100 can receive a request to generate an adaptive function link 202 for a content item 201. The adaptive link system 100 can generate the adaptive function link 202 by defining a link script 204 which calls a computer function 206. As shown, the adaptive link system 100 can define the link script 204 as a segment of computer code that executes upon selection of the adaptive function link 202. The adaptive link system 100 thus embeds the computer function 206 in the link script 204 such that, upon selection, the adaptive link system 100 executes the computer function 206 within the link script.

In response to selection of the adaptive function link 202, the adaptive link system 100 can parse the link script 204 to determine one or more computer functions embedded in the link script 204, including the computer function 206. The adaptive link system 100 further executes the computer function 206 to determine a large language model 208 instantiated by the adaptive function link 202. In some cases, the adaptive link system 100 parses the link script 204 to determine that the computer function 206 instantiates the large language model 208 without (or before) executing the computer function 206 to call the large language model 208. In other cases, the adaptive link system 100 executes the computer function 206 to instantiate the large language model 208. The computer function 206 can also include instructions (e.g., a prompt) for instructing the large language model 208 to modify the content item 201 in a particular fashion.

As noted, and as indicated by the dashed lines around the large language model 208, the adaptive link system 100 can optionally utilize adaptive function link 202 to instantiate the large language model 208. Indeed, the adaptive link system 100 can cause the adaptive function link 202 to instantiate computer functions in addition or alternatively to the large language model 208. For example, in some embodiments, the adaptive link system 100 can parse the link script 204 to determine an API to perform the computer function 206. Moreover, in some embodiments, the adaptive link system 100 can parse the link script 204 to determine a web browser or an application to perform the computer function 206.

As shown in FIG. 2, the adaptive link system 100 can perform the computer function 206 (e.g., by utilizing the large language model 208 or some other functionality), to generate modified version(s) of the content item 214. Indeed, the adaptive link system 100 can execute the computer function 206 to modify the content item 201 by changing information contained in the content item 201. For example, in some embodiments, the adaptive link system 100 can modify the content item 201 by redacting information from the content item 201 to generate a redacted version of the content item 210.

Additionally, in some embodiments, the adaptive link system 100 can modify the content item 201 by translating text in the content item 201 from a first language into a second language (e.g., from English to Spanish) to generate a translated version of the content item 212. Moreover, in some embodiments, the adaptive link system 100 can perform multiple computer functions to modify the content item 201 in a plurality of ways. For example, the adaptive link system 100 can redact and translate the content item 201.

Moreover, in some embodiments, adaptive link system 100 can receive a second request to share the content item 201 with a second client device. That is, in response to receiving the modified version(s) of the content item 214, the adaptive link system 100 can receive a second request to share the content item 201. Indeed, the adaptive link system 100 can determine that the second request indicates a second computer function for modifying the content item upon sharing with the second client device. For example, the adaptive link system 100 can determine that the second computer function indicates a different type of modified content to generate.

In response to the second request, the adaptive link system 100 can generate a second adaptive function link for the content item 201 by embedding the second computer function within a second link script of a second adaptive function link. That is to say, the computer function 206 can be the second computer function, the link script 204 can the second link script, and the modified version(s) of the content item 214 can be the second modified version of the content item.

Additionally, in response to receiving, from the second client device, an indication of a selection of the second adaptive function link, the adaptive link system 100 can perform the second computer function embedded in the second link script to generate a second modified version of the content item. Additionally, the adaptive link system 100 can provide the second modified version of the content item for display on the second client device. In this manner, the adaptive link system 100 can facilitate a requester client device sending a first adaptive function link to a first recipient client device and can also facilitate the requester client device sending a second adaptive function link to a second recipient client device. Additionally or alternatively, the adaptive link system 100 can facilitate the requester client device sending a first adaptive function link to a first recipient client device. Thereafter, the first recipient device can send a second adaptive function link to a second recipient client device. Accordingly, the adaptive link system 100 can structure the adaptive function link to generate the modified version of the client device according to parameters specified by multiple client devices.

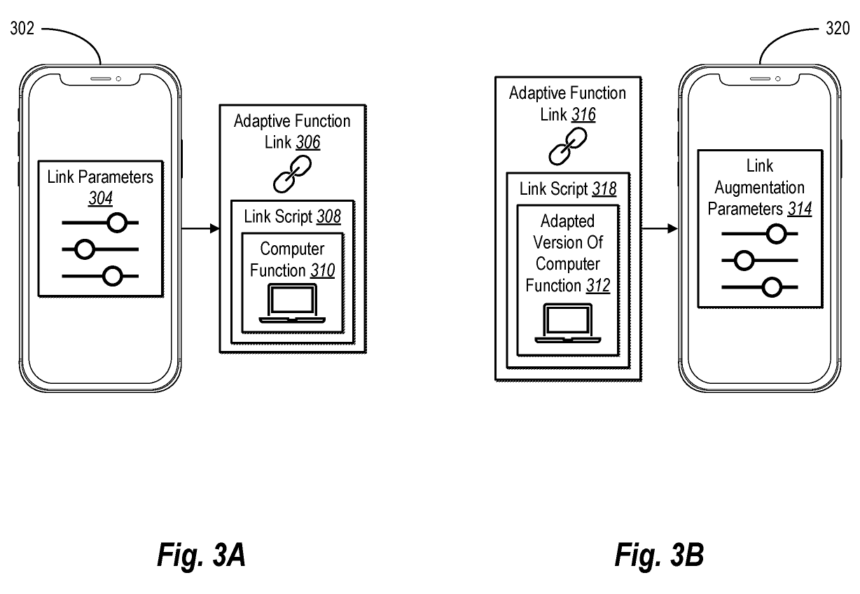

As previously mentioned, the adaptive link system 100 can generate and/or otherwise modify the adaptive function link according to parameters of various client devices. For example, FIG. 3A shows the adaptive link system 100 creating the adaptive function link according to link parameters associated with a requesting client device (e.g., a client device that provides the request to generate the link, without regard to sharing the link) in accordance with one or more embodiments. Additionally, FIG. 3B shows the adaptive link system 100 modifying the adaptive function link according to link augmentation parameters associated with recipient client devices (e.g., client devices that receive the adaptive function link after the adaptive link system 100 creates the adaptive function link) in accordance with one or more embodiments.

As shown in FIG. 3A, the adaptive link system 100 can determine a computer function 310 to embed in a link script 308 of an adaptive function link 306 according to link parameters 304 of a requesting client device 302. As used herein, the term “link parameters” refers to criteria or metrics defining the adaptive function link received from and/or otherwise set by a requesting client device 302 (e.g., a client device generating/requesting creation of the adaptive function link). Specifically, the link parameters 304 can be initial criteria for the adaptive function link 306 defined by the requesting client device upon link creation (e.g., before sharing the adaptive function link 306). For example, the link parameters 304 can indicate a type of modification to perform on a content item. Additionally, the link parameters 304 can determine a level of modification to perform on the content item, such as an amount and/or type of content to redact and/or a target language for translating content. The adaptive link system 100 can determine the link parameters 304 according to input from the requesting client device 302. Moreover, the adaptive link system 100 can determine the link parameters 304 by requesting input from the requesting client device 302 regarding an appearance of the adaptive function link 306 (e.g., the adaptive link system 100 can determine to truncate the adaptive function link 306). Additionally, in some embodiments, the adaptive link system 100 can autonomously determine the link parameters 304 by analyzing data of the requesting client device 302.

As noted, in some embodiments, the adaptive link system 100 can autonomously (e.g., without user input or interaction) determine the link parameters 304. For example, the adaptive link system 100 can determine the link parameters 304 by determining an expiration date for the adaptive function link 306. Moreover, the adaptive link system 100 can determine the link parameters 304 by determining visual indicators for the adaptive function link 306, such as an icon or a badge. In addition, the adaptive link system 100 can determine the link parameters 304 by determining protocols for the adaptive function link 306 (e.g., http, https, ftp, etc.). Moreover, in some embodiments, the adaptive link system 100 can determine the link parameters 304 according to previously redacted content and/or previously generated redacted versions of content items. The adaptive link system 100 can likewise determine the link parameters 304 based on previously generated translated versions of content items and/or other types of previously generated modified versions of content items. Further, the adaptive link system 100 can determine the link parameters 304 according to an indication of one or more types of PII (or other types of content) in the content item. Additionally, in some embodiments, the adaptive link system 100 can predict a recipient of the adaptive function link 306 (e.g., a recipient client device) according to previously generated and/or similar adaptive function links, and can determine the link parameters 304 according to the predicted recipient.

In addition, in one or more embodiments, the adaptive link system 100 can determine the link parameters 304 according to types of content items the requesting client device 302 accesses and/or types of information contained in the content items the requesting client device 302 accesses. For example, the adaptive link system 100 can determine the link parameters 304 by determining that the requesting client device 302 accesses content items that contain sensitive types of information, such as PII, PHI, confidential information, etc. Moreover, the adaptive link system 100 can determine the link parameters 304 according to types of actions taken by the requesting client device 302 (e.g., actions taken within a content management system). For example, the adaptive link system 100 can determine the link parameters 304 by determining that the requesting client device 302 frequently shares and/or edits content items.

As shown in FIG. 3B, the adaptive link system 100 can generate an adapted version of a computer function 312. For instance, the adaptive link system 100 can modify or adapt a computer function (e.g., the computer function 310) according to link augmentation parameters 314 associated with the recipient client device 320. The adaptive link system 100 can embed the adapted version of the computer function 312 in a link script 318 of an adaptive function link 316. As used herein, the term “link augmentation parameters” refers to parameters or metrics that define one or more modifications to an adaptive function link. Indeed, the link augmentation parameters 314 can refer to criteria or parameters associated with the recipient client device 320 that cause the adaptive link system 100 to update or modify the adaptive function link 316 (from its original form as set by initial link parameters). For example, the link augmentation parameters can indicate a type of modification for a content item (e.g., a different type of modification than the adaptive function link indicated prior to modification of the adaptive function link according to the link augmentations parameters). Additionally, the link augmentation parameters can indicate a level or degree of modification for a content item (e.g., a different level or degree of modification than the adaptive function link indicated prior to modification of the adaptive function link according to the link augmentation parameters). In some cases, the link augmentation parameters 314 cause the adaptive link system 100 to update the adaptive function link 316 specifically for the recipient client device 320 by generating the adapted version of the computer function 312. The adaptive link system 100 can determine the link augmentation parameters 314 according to input from the recipient client device 320. Moreover, in some embodiments, the adaptive link system 100 can autonomously determine the link augmentation parameters by analyzing data and/or metadata of the recipient client device 320.

Indeed, as shown in FIG. 3B, the adaptive link system 100 can determine link augmentation parameters 314 from the recipient client device 320. In some embodiments, the adaptive link system 100 can determine different augmentation parameters (which results in different modified versions of a content item) for different recipient devices of the same adaptive function link 316. Indeed, in one or more embodiments, the adaptive link system 100 can generate the adaptive function link 316 to adapt on a per-device basis, where each recipient device has its own augmentation parameters which change how the computer function 310 modifies a content item (e.g., for translating into different languages and/or for redacting different content). In other words, by implementing the link augmentation parameters 314, the adaptive link system 100 can generate the adapted version of the computer function 312 specifically for the recipient client device 320.

In some embodiments, the adaptive link system 100 can determine the link augmentation parameters 314 by requesting input from the recipient client device 320. Thus, in some embodiments, the adaptive link system 100 can generate the link augmentation parameters 314 according to input from the recipient client device 320. For example, the adaptive link system 100 can execute a computer function (as initially defined by the link parameters 304) to perform a custom redaction or translation on a content item according to the link augmentation parameters 314. In turn, the adaptive link system 100 can determine a level (e.g., an amount) and/or a type of modification (e.g., a redaction and/or translation) according to the link augmentation parameters 314.

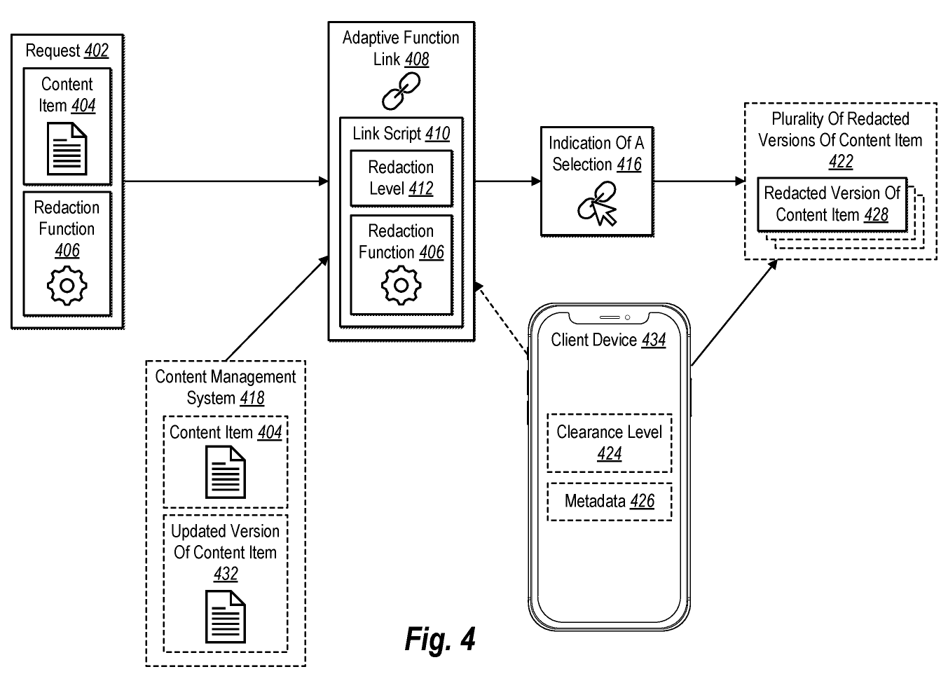

As previously mentioned, the adaptive link system 100 can generate a modified content item using an adaptive function link. In particular, the adaptive link system 100 can embed and utilize a redaction function to generate a redacted version of a content item. FIG. 4 illustrates generating and utilizing a redaction function of an adaptive function link to generate a redacted content item in accordance with one or more embodiments.

As shown in FIG. 4., the adaptive link system 100 can receive a request 402 to generate a link for a content item 404. Indeed, the adaptive link system 100 can determine a redaction function 406 to apply to the content item 404 from the request 402. For example, the adaptive link system 100 can receive a request 402 to generate a link for a redacted version of a content item 428. The request 402 can define both the content item 404 and the redaction function 406 (including instructions, such as a prompt for a large language model, of which content and/or how much content to redact) to apply to the content item 404.

Moreover, in some embodiments, the request 402 can define a redaction level 412 to apply to the content item 404. The request 402 can define parameters for the redaction function 406 that indicate the redaction level 412 for the adaptive link system 100 to embed in a link script 410 of an adaptive function link 408. Additionally, the adaptive link system 100 can utilize parameters associated with a client device 434 to generate the adaptive function link 408 and/or determine the redaction level 412.

For example, in some embodiments, the adaptive link system 100 can determine the redaction level 412 for the redaction function 406 based on metadata 426 associated with the client device 434. In some embodiments, the adaptive link system 100 can determine the redaction level 412 according to metadata 426 associated with a user account of the client device 434. Indeed, the adaptive link system 100 can determine a plurality of redaction levels according to metadata associated with the client device 434 and generate a plurality of adaptive function links according to the plurality of redaction levels. Additionally, in some embodiments, the adaptive link system 100 can generate a plurality of redacted versions of the content item and generate an adaptive function link for a redacted version of the content item of the plurality of redacted versions of the content item responsive to receiving the indication of the selection 416 of the adaptive function link 408 from the client device 434.

As shown, the adaptive link system 100 receives an upload of the content item 404 to a content management system 418. For instance, the adaptive link system 100 receives the upload from a client device, such as the same client device which submits the request 402 for creating the adaptive function link 408. The adaptive link system 100 can generate a plurality of redacted versions of the content item 422 upon creation of the adaptive function link 408. In some cases the adaptive link system 100 generates multiple redacted versions upon detecting an upload of the content item 404 to the content management system 418 according to respective redaction levels, based on link parameters of the requesting device.

Additionally, the adaptive link system 100 can detect an updated version of the content item 432. For example, the adaptive link system 100 can determine that a client device has added, removed, or otherwise changed content within the content item 404. Responsive to detecting the updated version of the content item 422, the adaptive link system 100 can update the adaptive function link 408 to reference the updated version of the content item 432. Additionally, in some embodiments, responsive to detecting the updated version of the content item 432, the adaptive link system 100 can update and/or otherwise modify the redaction level 412 associated with the updated version of the content item 432.

As illustrated, in response to receiving the request 402, the adaptive link system 100 can generate an adaptive function link 408. As part of generating the adaptive function link 408, the adaptive link system 100 can embed the redaction function 406 within the link script 410 such that the redaction function 406 is instantiated upon selection of the adaptive function link 408. Moreover, in some embodiments, the adaptive link system 100 can parse the link script 410 to determine the redaction level 412 (e.g., that indicates a quantity and/or type of information to redact) interpretable by the redaction function 406 (which may be a large language model). As an example of the redaction level 412, the adaptive link system 100 generates or modifies a prompt for a large language model by including language defining an amount and/or type of redaction to perform. The adaptive link system 100 can thus perform or execute the redaction function 406 according to the redaction level 412.

As illustrated, responsive to receiving an indication of a selection 416 of the adaptive function link 408, the adaptive link system 100 can perform the redaction function 406 embedded in the link script 410 to generate a redacted version of the content item 428. Indeed, in some embodiments, the adaptive link system 100 can perform the redaction function 406 embedded in the link script 410 according to a plurality of redaction levels (as indicated by a combination of link parameters of a device initiating the request 402 and/or link augmentation parameters of the client device 434) to generate a plurality of redacted versions of the content item 422. Indeed, responsive to the indication of the selection 416 of the adaptive function link 408, the adaptive link system 100 executes the redaction function 406 embedded in the link script 410 of the adaptive function link 408. The adaptive link system 100 can cause the adaptive function link 408 to generate a prompt, such as a prompt for an LLM, that includes instructions to redact content from the content item 404 (e.g., the instructions can include an indication of the redaction level 412). The adaptive link system 100 can provide the prompt and the content item 404 to the LLM, and the LLM can return the redacted version of the content item 428.

As indicated by the dashed lines of the plurality of redacted versions of the content item 422, in some embodiments, the adaptive link system 100 can optionally determine to generate the plurality of redacted versions of the content item 422. Indeed, in some embodiments, the adaptive link system 100 can determine to generate the plurality of redacted versions of the content item 422 responsive to receiving the request 402. Additionally, the adaptive link system 100 can store the plurality of redacted versions of the content item (such as, for example, in the content management system 418). In some embodiments, the adaptive link system 100 can access the plurality of redacted versions of the content item 422 responsive to the indication of the selection 416 of the adaptive function link 408. Additionally, in some embodiments, the adaptive link system 100 can determine the redacted version of the content item 428 from the plurality of redacted versions of the content item to provide to the client device 434 responsive to the indication of the selection 416 of the adaptive function link 408. Additionally or alternatively, in some embodiments, the adaptive link system 100 can generate the redacted version of the content item 428 in real time responsive to the indication of the selection 416 of the adaptive function link 408.

Moreover, as shown, in some embodiments, the adaptive link system 100 can select or generate a redacted version of the content item 428 according to parameters (e.g., link augmentation parameters) associated with a client device 434. Additionally, in some embodiments, the adaptive link system 100 can select or generate the redacted version of the content item 428 according to metadata 426 of a user account associated with the client device 434. For example, the adaptive link system 100 can determine a clearance level 424 of the client device or of a user account associated with the client device. As used herein, the term “clearance level” means a level of classification associated with a client device or a user account. For example, the clearance level can be a security credential that indicates and/or otherwise determines what types of information a client device or a user account has access to within an organization or a content management system. For example, a clearance level can indicate that a client device or a user account has access to certain categories of PII contained in a content item, but not other confidential information within the content item and/or the modified version of the content item (e.g., a redacted version and/or a translated version). Moreover, a clearance level can also indicate what types of actions a client device can perform regarding a content item and/or a modified version of the content item. For example, a clearance level can indicate that a client device can create, preview, share, and/or edit a content item.

As previously mentioned, the adaptive link system 100 can generate the redacted version of the content item 428 according to link augmentation parameters, such as a clearance level, associated with the client device 434. Responsive to determining the clearance level 424 of the client device 434, the adaptive link system 100 can select the redacted version of the content item 428 from the plurality of redacted versions of the content item 422 according to the clearance level 424. For example, the adaptive link system 100 can determine that the content item 404 and/or the updated version of the content item 432 contains information that is above the clearance level 424 of the client device 434. The adaptive link system 100 can select the redacted version of the content item 428 from the plurality of redacted versions of the content item 422 according to the clearance level 424 (e.g., the adaptive link system 100 can determine the redacted version of the content item 428 by determining a version of the plurality of redacted versions where the adaptive link system 100 redacted the information that is above the clearance level 424 of the client device 434).

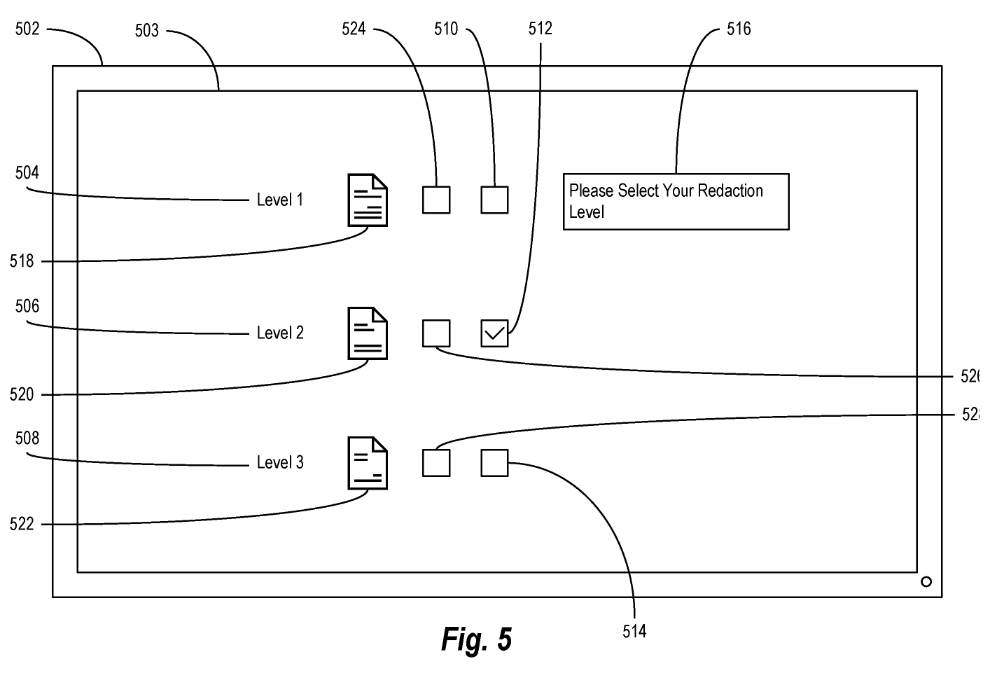

As previously mentioned, the adaptive link system 100 can generate a preview of a redacted version of a content item. FIG. 5 illustrates the adaptive link system 100 generating a plurality of redacted versions of a content item and providing the plurality of redacted versions for display in a user interface of a client device.

Indeed, as shown, the adaptive link system 100 can generate a plurality of redacted versions of the content item and can provide them for preview and/or display in a user interface 503 of a client device 502. For each of the plurality of redacted versions of the content idem, the adaptive link system 100 can provide an indication of a redaction level applied to the respective version of the content item. For example, the adaptive link system 100 can provide a first indication of the redaction level 504 to indicate that the adaptive link system 100 applied a “Level 1” redaction function to a first redacted version of the content item 518. Additionally, the adaptive link system 100 can provide a second indication of the redaction level 506 to indicate that the adaptive link system 100 applied a “Level 2” redaction function to a second redacted version of the content item 520. Moreover, the adaptive link system 100 can provide a third indication of the redaction level 508 to indicate that the adaptive link system 100 applied a “Level 3” redaction function to a third redacted version of the content item 522.

Moreover, as shown, the adaptive link system 100 can generate a plurality of user interface elements selectable to generate a preview of the respective redacted version of the content item. For example, the adaptive link system 100 can generate a first user interface element 524 selectable to generate a preview the first redacted version of the content item 518 (e.g., the first redacted version of the content item 518 that the adaptive link system 100 generated by applying the “Level 1” redaction function to the content item). Additionally, the adaptive link system 100 can generate a second user interface element 526 selectable to generate a preview of the second redacted version of the content item 520 (e.g., the second redacted version of the content item 520 that the adaptive link system 100 generated by applying the “Level 2” redaction function to the content item). Indeed, the adaptive link system 100 can generate a third user interface element 528 selectable to generate a preview of the third redacted version of the content item 522 (e.g., the third redacted version of the content item 522 that the adaptive link system 100 generated by applying the “Level 3” redaction function to the content item).

Further, as illustrated, the adaptive link system 100 can generate a fourth user interface element 516 to provide instruction to confirm the application of the redaction level to the content item. Additionally, the adaptive link system 100 can generate a plurality of user interface elements 510, 512, and 514 to provide an indication of approval of the preview the redaction level. Based on receiving an indication of approval of the preview vie a user interface element of the plurality of user interface elements (e.g., such as is indicated by 512), the adaptive link system 100 can generate the adaptive function link for the content item. Specifically, the adaptive link system 100 can generate the adaptive function link for the content item according to the redaction level.

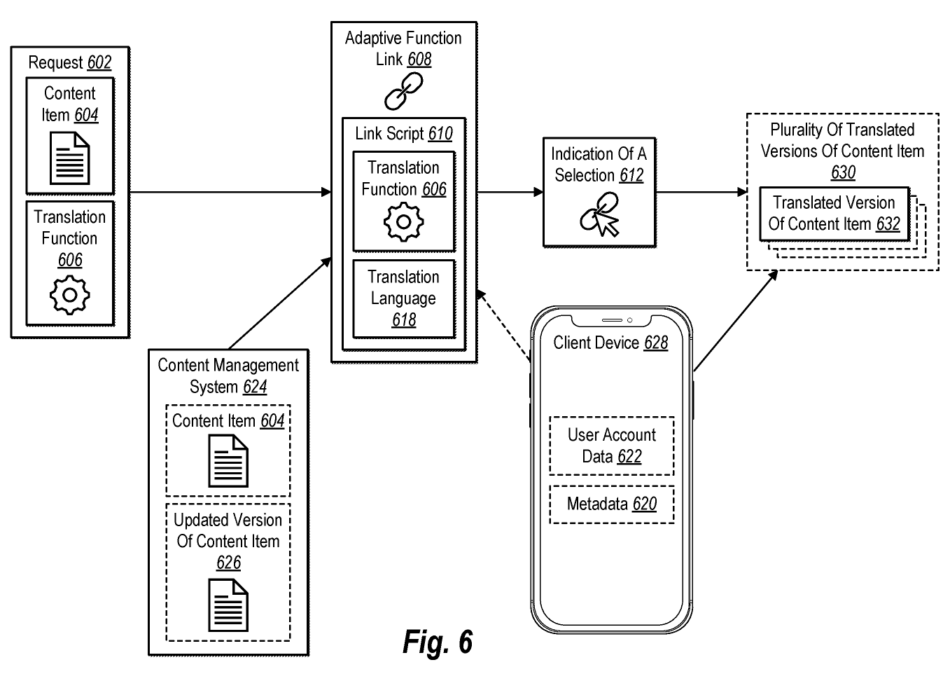

As previously mentioned, the adaptive link system 100 can utilize an adaptive function link to generate a translated version of a content item. In particular, the adaptive link system 100 can generate translated versions of a content item depending on link parameters of a sender device and/or link augmentation parameters of a recipient device. FIG. 6 shows the adaptive link system 100 receiving a request 602 to generate a link for a content item 604. Indeed, the adaptive link system 100 can determine a translation function 606 to apply to the content item 604 from the request 602. For example, the adaptive link system 100 can receive a request 602 to generate a link for a translated version of a content item 632. The request 602 can define both the content item 604 and the translation function 606 (including instructions, such as a prompt for a large language model, of which content and/or how much content to translate) to apply to the content item 604.

As shown in FIG. 6, the adaptive link system 100 can receive the request 602 to generate a link for a content item 604. The adaptive link system 100 can determine that the request specifies a translation function 606 to execute based on selection of the link. For example, the adaptive link system 100 can receive a request 602 to generate a link for a translated version of a content item 632. From the request 602, the adaptive link system 100 can determine both the content item 604 and the translation function 606 to apply to the content item 604.

Moreover, in some embodiments, the request 602 can define a translation language 618 to apply to the content item 604. The request 602 can define parameters for the translation function 606 that indicate the translation language 618 for the adaptive link system 100 to embed in a link script 610 of an adaptive function link 608. Additionally, the adaptive link system 100 can utilize link parameters associated with a device submitting the request 602 and/or link augmentation parameters associated with a client device 628 to generate the adaptive function link 608 and/or determine the translation language 618. For example, in some embodiments, the adaptive link system 100 can determine the translation language 618 for the translation function 606 based on metadata 620 associated with the client device 628 or user account data 622 associated with a user account of the client device 628.

As shown, the adaptive link system 100 receives an upload of a content item 604 to a content management system 624. For instance, the adaptive link system 100 receives the upload from a client device, such as the same client device which submits the request 602 for creating the adaptive function link 608. The adaptive link system 100 can generate a plurality of translated versions of the content item 630 upon creation of the adaptive function link 608. In some cases the adaptive link system 100 generates multiple translated versions upon detecting an upload of the content item 604 to the content management system 624 according to respective translation languages, based on link parameters of the requesting device.

Additionally, the adaptive link system 100 can detect an updated version of the content item 626. For example, the adaptive link system 100 can determine that a client device has added, removed, or otherwise changed content within the content item 604. Responsive to detecting the updated version of the content item 626, the adaptive link system 100 can update the adaptive function link 608 to reference the updated version of the content item 626. Additionally, in some embodiments, responsive to detecting the updated version of the content item 626, the adaptive link system 100 can update and/or otherwise modify the translation language 618 associated with the updated version of the content item 626.

As shown, responsive to receiving the request 602, the adaptive link system 100 can generate an adaptive function link 608 for the content item 604 and embed the translation function 606 within the link script 610 of the adaptive function link 608. Moreover, in some embodiments, the adaptive link system 100 can parse the link script 610 to determine the translation language 618 to apply to the content item 604 (e.g., a translation language indicated by the translation function). Indeed, the adaptive link system 100 can perform the translation function 606 according to the translation language 618 indicated by the translation function 606. That is to say, the adaptive link system 100 can determine an origin language (e.g., a language of the content item 604) and a desired language (e.g., a language for the translated version of the content item) and embed both the origin language and the desired language in the link script 610 of the adaptive function link 608.

Additionally, in some embodiments, the adaptive link system 100 can determine a plurality of translation languages and can generate the plurality of translated versions of the content item 630 according to respective translation languages from the plurality of translation languages. For example, the adaptive link system 100 can determine a first plurality of translation languages according to metadata 620 associated with a requester device and/or a recipient device and a second plurality of translation languages according to user account data 622 associated with a requester device and/or a recipient device. The adaptive link system 100 can generate the plurality of translated versions of the content item 630 according to the first plurality of translation languages and the second plurality of translation languages.

Moreover, in some embodiments, the adaptive link system 100 can determine the translation language 618 to apply via the translation function 606 by determining a language score for the translation language 618. Indeed, the adaptive link system 100 can determine the language score according to multiple factors of the requester device and/or the recipient device, such as a domain address, language settings, languages of additional content items associated with the client device and/or the requester device, among others. Indeed, the adaptive link system 100 can utilize the language score to determine the translation language 618 for the translated version of the content item 632 when the adaptive link system 100 detects multiple possible translation languages.

As shown, in some embodiments the adaptive link system 100 can determine the translation language 618 according to metadata 620 associated with a client device 628. In this instance, the client device 628 can be a requesting device (e.g., a client device that requests for the adaptive link system 100 to generate the adaptive function link 608) or a recipient client device (e.g., a client device that receives the adaptive function link 608 from the requesting device). For example, the adaptive link system 100 can determine the translation language 618 according to metadata 620 associated with a requesting client device or a recipient client device.

Additionally, in some embodiments, the adaptive link system 100 can determine the translation language 618 according to user account data 622 for a user account associated with the client device 628. For instance, the adaptive link system 100 can determine a user account associated with a requesting client device, and utilize the user account data 622 associated with the requesting client device to determine the translation language 618. Additionally or alternatively, the adaptive link system 100 can determine a user account associated with a recipient client device, and utilize the user account data 622 associated with the recipient client device to determine the translation language 618.

Indeed, in some embodiments, the adaptive link system 100 can determine that the metadata 620 of the client device 628 indicates a first translation language and that the user account data for the user account associated with the client device 628 indicates a second translation language. Responsive to this determination, the adaptive link system 100 can provide a notification on the client device 628 requesting a determination of whether to use the first translation language or the second translation language as the translation language 618.

As shown in FIG. 6, in some embodiments, the adaptive link system 100 generate the adaptive function link 608 based on monitoring a content management system 624. Indeed, the adaptive link system 100 can detect an upload of the content item 604 to a content management system 624. Responsive to detecting the upload, the adaptive link system 100 can generate the adaptive function link 608 for the content item. Moreover, the adaptive link system 100 can detect an updated version of the content item 626 (e.g., the adaptive link system 100 can detect one or more changes to the content item 604). Responsive to detecting the updated version of the content item 626, the adaptive link system 100 can update the adaptive function link 608 to reference the updated version of the content item 626. Additionally, responsive to detecting the updated version of the content item 626, the adaptive link system 100 can determine to update and/or otherwise modify the translation language 618 indicated by the adaptive function link 608.

As illustrated, responsive to receiving an indication of a selection 612 of the adaptive function link 608, the adaptive link system 100 can perform the translation function 606 embedded in the link script 610 of the adaptive function link to generate a plurality of translated versions of the content item 630. For example, responsive to the indication of the selection 612 of the adaptive function link 608, the adaptive link system 100 executes the translation function 606 embedded in the link script 610 of the adaptive function link 608. The adaptive link system 100 can cause the adaptive function link to generate a prompt, such as a prompt for an LLM, that includes instructions to translate the content item 604 from a first language to a second language (e.g., the instructions can include an indication of the translation language 618). The adaptive link system 100 can provide the prompt and the content item 604 to the LLM, and the LLM can return the translated version of the content item 632.

As indicated by the dashed lines of the plurality of translated versions of the content item 630, in some embodiments, the adaptive link system 100 can optionally determine to generate the plurality of translated versions of the content item 630. Indeed, in some embodiments, the adaptive link system 100 can determine to generate the plurality of translated versions of the content item 630 responsive to receiving the request 602. Additionally, the adaptive link system 100 can store the plurality of redacted versions of the content item (such as, for example, in the content management system 624). In some embodiments, the adaptive link system 100 can access the plurality of translated versions of the content item 630 responsive to the indication of the selection 612 of the adaptive function link 608. Moreover, in some embodiments, the adaptive link system 100 can determine the translated version of the content item 632 from the plurality of translated versions of the content item 630 to provide to the client device 628 responsive to the indication of the selection 612 of the adaptive function link 608. Additionally or alternatively, in some embodiments, the adaptive link system 100 can generate the translated version of the content item 632 in real time responsive to the indication of the selection 612 of the adaptive function link 608.

Additionally, as shown, the adaptive link system 100 can select or generate the translated version of the content item 632 from the plurality of translated versions of the content item 630. For example, the adaptive link system 100 can utilize the metadata 620 of the client device 628 and/or the user account data of the client device 628 to determine the translated version of the content item from the plurality of translated versions of the content item. Additionally, in some embodiments, rather than generating the plurality of translated versions of the content item 630 and determining the translated version of the content item 632 from the plurality of translated versions of the content item 630, the adaptive link system 100 can generate the translated version of the content item.

Further, in some embodiments, the adaptive link system 100 can determine that the translation language 618 is a hybrid language. For example, the adaptive link system 100 can determine a first translation language associated with a requester client device (e.g., English). Additionally, the adaptive link system 100 can determine a second translation language associated with a recipient client device (e.g., Spanish). Responsive to determining the first translation language and the second translation, the adaptive link system 100 can determine to combine the first translation language and the second translation language to embed a hybrid language (e.g., Spanglish) in the link script 610 of the adaptive function link 608.

Moreover, in one or more embodiments, the adaptive link system 100 can detect a hybrid language in the content item 604. For example, the adaptive link system 100 can detect that the content item 604 is in Spanglish. Responsive to detecting the hybrid language, the adaptive link system 100 can determine a first translation language and a second translation language from the hybrid language. For example, responsive to detecting that the content item 604 is in Spanglish, the adaptive link system 100 can determine that the first translation language is Spanish and that the second translation language is English. Based on determining the first translation language and the second translation language, the adaptive link system 100 can generate a duality of adaptive function links by embedding a first translation function for the first translation language in a first link script of a first adaptive function link and embedding a second translation function for the second translation language in a second link script of a second adaptive function link.

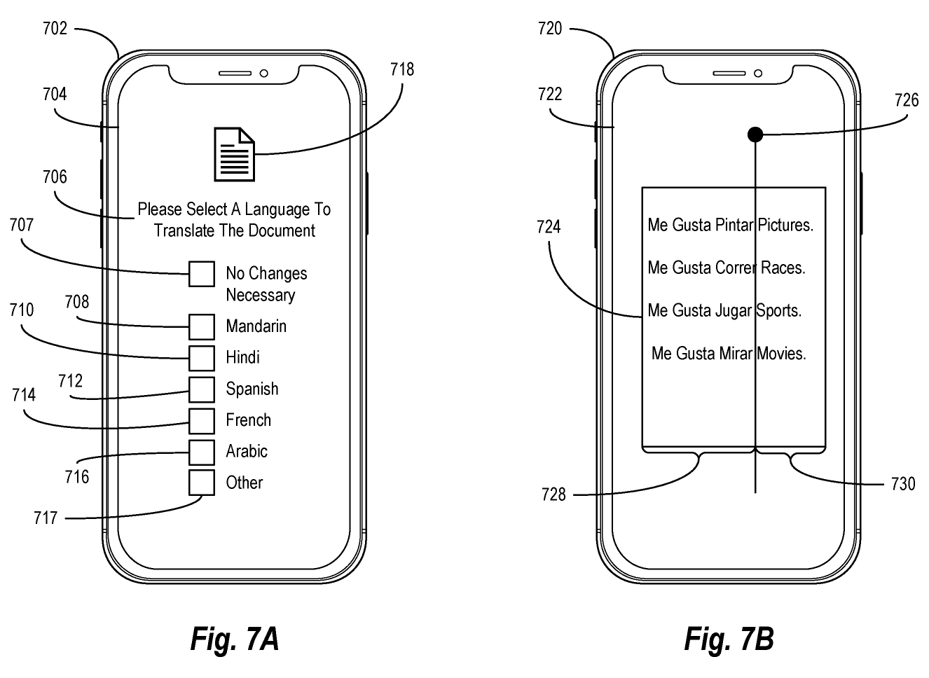

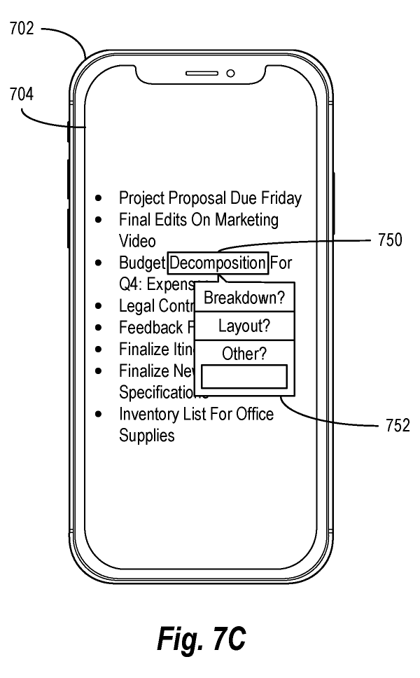

As previously mentioned, the adaptive link system 100 can generate previews of translated versions of content items. FIG. 7A illustrates the adaptive link system 100 generating a preview of a translated version of a content item and requesting an indication of approval for the translated version of the content item in accordance with one or more embodiments. FIG. 7B illustrates the adaptive link system 100 utilizing an overlay function to generate a preview of a translated version of a content item to provide in a second user interface of a second client device (e.g., a recipient client device) in accordance with one or more embodiments.

FIG. 7A illustrates the adaptive link system 100 generating a preview 718 of a translated content item. in a user interface 704 of a requester client device 702. For example, the adaptive link system 100 can determine a translation language for the translated version of the content item from metadata of the requester client device 702 or user account data of a user account associated with the requester client device 702. According to the metadata or user account data, the adaptive link system 100 can generate the preview 718 of the translated content item. Indeed, the adaptive link system 100 can request an indication of approval 706 for the translated version of the content item through the user interface 704 of the requester client device. The adaptive link system 100 can generate a user interface element 707 for the user account to indicate approval of the translated version of the content item. Responsive to detecting an interaction with the user interface element 707 for the user account to indicate approval of the translated version of the content item, the adaptive link system 100 can generate the adaptive function link.

In some embodiments, the request for the indication of approval 706 can be an indication of a request for a modified translation function to translate the content item to a different language. For example, responsive to generating the preview 718 of the translated version of the content item, the adaptive link system 100 can receive, from the requester client device 702, an indication of a request for a modified translation function to translate the content item to a different language. In some embodiments, responsive to receiving this request, the adaptive link system 100 can generate a plurality of user interface elements 708, 710, 712, 714, 716 and 717 to indicate a translation language to include in the translation function of the adaptive function link. Based on the indication of the request for the modified translation function (e.g., based on detecting an interaction with one of the plurality of user interface elements 708, 710, 712, 714, 716, or 717), the adaptive link system 100 can update the adaptive function link by embedding the modified translation function within a link script of the adaptive function link.

As shown in FIG. 7B, the adaptive link system 100 can utilize an overlay layer 726 to generate a modified appearance of a content item 724. Indeed, the adaptive link system 100 can provide the overlay layer 726 in a user interface 722 of a client device 720, where the overlay layer 726 is an appearance augmenter that changes how content appears (e.g., the language of digital text) without changing the underlying content itself. The client device 720 can be a requester client device or a recipient client device. Indeed, a user account associated with the client device 720 can utilize the overlay layer 726 to modify an appearance of the content item 724. For example, the adaptive link system 100 can utilize the overlay layer 726 to generate a real-time translation of the content item 724. Through the overlay layer 726, the adaptive link system 100 can generate the modified appearance of the content item by translating a first portion of the content item 728 into the translation language. Indeed, the adaptive link system 100 can utilize the overlay layer 726 to keep a second portion of the content item 730 in the original language of the content item.

Moreover, the adaptive link system 100 can utilize the overlay layer 726 to generate a preview of the translated version of the content item or to generate the translated version of the content item. In some embodiments, the adaptive link system 100 can utilize the overlay layer 726 to generate the preview of the translated version of the content item and request approval of the translated version of the content item prior to generating the adaptive function link. Additionally, in some embodiments, the adaptive link system 100 can utilize the overlay layer 726 to generate the translated version of the content item responsive to receiving an indication of a selection of the adaptive function link.

Moreover, the adaptive link system 100 can autonomously determine when to implement the overlay layer 726. For example, the adaptive link system 100 can monitor criteria such as bandwidth within a content management system, a file size of the content item, or types of information contained in the content item. The adaptive link system 100 can determine whether to generate a plurality of adaptive function links corresponding to a plurality of translation languages (e.g., each of the plurality of adaptive function links can generate a translated version of the content item according to different translation languages), to generate a plurality of translated versions of the content item, or to embed the overlay layer 726 as a part of the link script of the adaptive function link, thus enabling a user account associated with the client device 720 to modify an appearance of the content item 724 (e.g., in real-time) to reflect translated content.

Additionally, while FIG. 7B illustrates the adaptive link system 100 generating the overlay layer 726 to move horizontally across the content item 724 within the user interface, thus creating a horizontal split between the first portion of the content item 728 and the second portion of the content item 730, it should be understood that in some embodiments, the adaptive link system 100 can generate a second overlay layer to move vertically across the content item, thus creating a horizontal split between a third portion of the content item and a fourth portion of the content item. Indeed, the adaptive link system 100 can determine whether to generate a horizontal overlay layer or a vertical overlay layer. The adaptive link system 100 can determine information about the content item such as a type of the content item, a structure of the content item, an origin language of the content item, or a translation language for the translated version of the content item, and determine to generate the horizontal overlay layer or the vertical overlay layer according to the information about the content item.

As shown in FIG. 7C, the adaptive link system 100 can provide a user interface 704 to determine an update to the translated version of the content item in accordance with one or more embodiments. Specifically, the adaptive link system 100 can provide the translated version of the content item in the user interface 704. Indeed, the adaptive link system 100 can receive an indication of an incorrect translation 750 (e.g., as an input from a user account). Responsive to receiving the indication of the incorrect translation 750, the adaptive link system 100 can generate a corrective user interface element 752 to determine a correction for the incorrect translation. In some embodiments, the adaptive link system 100 can generate the corrective user interface element 752 to include alternative translation options for the incorrect translation. In some embodiments, the adaptive link system 100 can receive an input from a user account of the client device of a translation of the correction.

Responsive to determining the update, the adaptive link system 100 can generate an updated translated version of the content item to express the update. Additionally, the adaptive link system 100 can update the adaptive function link to reference the updated translated version of the content item. Further, the adaptive link system 100 can update the translation function (e.g., parameters of a large language model) using the updated translation to improve the performance of the translation function.

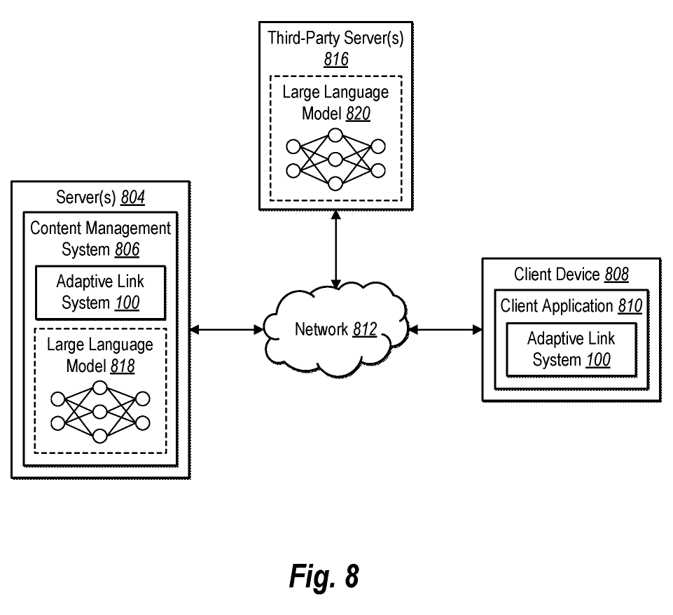

Additional detail regarding the adaptive link system will now be provided with reference to the figures. For example, FIG. 8 illustrates a schematic diagram of an example system environment for implementing an adaptive link system 100 in accordance with one or more implementations.

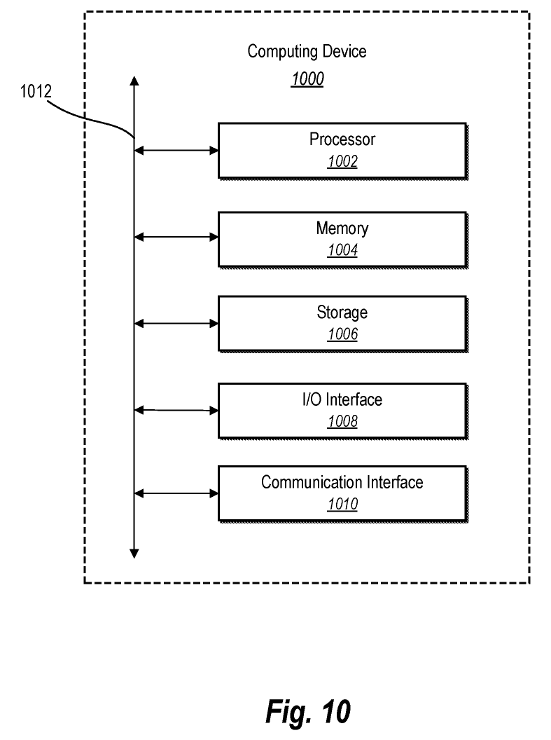

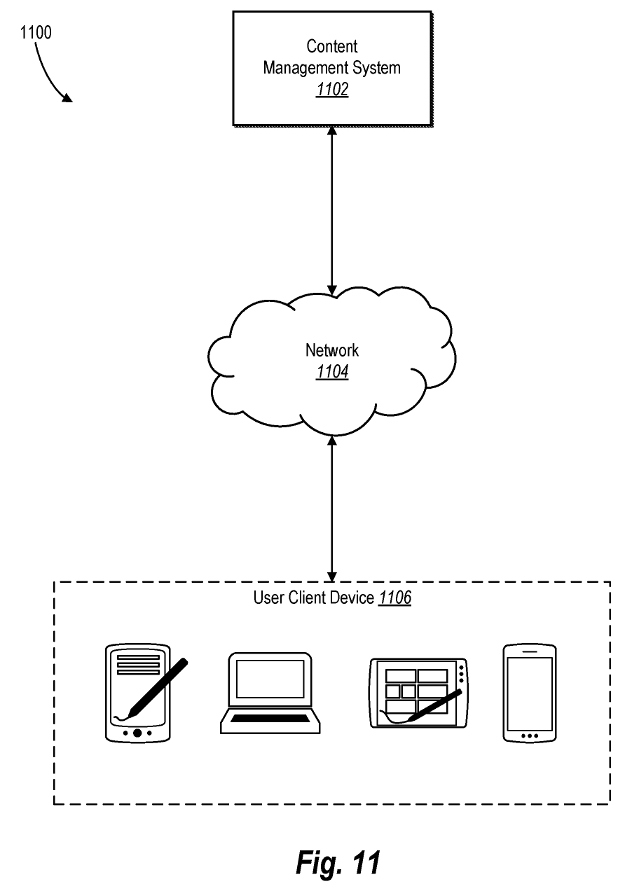

As shown, the environment includes server(s) 804, a client device 808, third-party servers 816 and a network 812. Each of the components of the environment can communicate via the network 812, and the network 812 may be any suitable network over which computing devices can communicate. Example networks are discussed in more detail below in relation to FIGS. 10-11.

As mentioned above the example environment includes a client device 808. The client device 808 can be one of a variety of computing devices, including a smartphone, a tablet, a smart television, a desktop computer, a laptop computer, a virtual reality device, an augmented reality device, or another computing device as described in relation to FIGS. 10-11. The client device 808 can communicate with the server(s) 804 via the network 812. For example, the client device 808 can receive user input from a user interacting with the client device 808 (e.g., via a client application 810) to, for instance, access, generate, modify, or share a content item, to collaborate with a co-user of a different client device, or to select a user interface element. In addition, the adaptive link system 100 on the server(s) 804 can receive information relating to various interactions with content items and/or user interface elements based on the input received by the client device 808 (e.g., to generate an adaptive function link for a modified content item and/or to modify the link and/or to further augment the modified version of the content item).

As shown, the client device can include a client application 810. In particular, the client application 810 may be a web application, a native application installed on the client device 808 (e.g., a mobile application, a desktop application, etc.), or a cloud-based application where all or part of the functionality performed by the server(s) 804. Based on instructions from the client application 810, the client device 808 can present or display information, including a user interface for previewing and/or editing modified versions of content items.

As illustrated in FIG. 8, the example environment also includes the server(s) 804. The server(s) 804 may generate, track, store, process, receive, and transmit electronic data, such as digital content (e.g., content items), LLMs, adaptive function links, modified versions of content items, redacted versions of content items, translated versions of content items, LLM interactions with digital content items, interactions with interface elements, and/or interactions between user accounts or client devices. In addition, the server(s) 804 can transmit data to the client device 808 in the form of content items or notifications. Indeed, the server(s) 804 can communicate with the client device 808 to send and/or receive data via the network 812. In some implementations, the server(s) 804 include(s) a number of server devices distributed across the network 812 and located in different physical locations. The server(s) 804 can comprise one or more content servers, application servers, communication servers, web-hosting servers, machine learnings servers, and other types of servers.

As shown in FIG. 8, the server(s) 804 can also include the adaptive link system 100 as part of the content management system 806. The content management system 806 can communicate with the client device 808 to perform various functions associated with the client application 810 such as managing user accounts, managing content collections, managing models managing model recommendations, managing content items, and facilitating user interaction with the modifications, the model recommendations, the content collections, and/or content items. Indeed, the content management system 806 can include a network-based smart cloud storage system to manage, store, and maintain content items, models, and related data across numerous user accounts, including user accounts in collaboration with one another.

Moreover, as illustrated the server(s) 804 can also include a large language model 818 as a part of the content management system 806. The large language model 818 can be native to, housed or hosted on, and/or maintained by the content management system 806.

Additionally, as shown in FIG. 8, the example environment includes third-party server(s) 816. The third-party server(s) 816 may generate, track, store, process, receive, and transmit electronic data, such as digital content (e.g., content items), LLMs, adaptive function links, modified versions of content items, redacted versions of content items, translated versions of content items, LLM interactions with digital content items, interactions with interface elements, and/or interactions between user accounts or client devices. In addition, the third-party server(s) 816 can transmit data to the client device 808 in the form of content items, modified versions of content items, redacted versions of content items, translated versions of content items, notifications about content items, notifications about modified, redacted, or translated versions of content items, interactions between client devices or between user accounts and client devices. Indeed, the third-party server(s) 816 can communicate with the client device 808 to send and/or receive data via the network 812. The third-party server(s) 816 can comprise one or more content servers, application servers, communication servers, web-hosting servers, machine learning servers, and other types of servers.

Indeed, as shown in FIG. 8, the third-party server(s) 816 can host a large language model 820, (e.g., a third-party large language model). The large language model 820 can execute computer functions embedded within link scripts of adaptive function links to generate modified versions of content items (e.g., redacted versions of content items or translated versions of content items).

Although FIG. 8 depicts the adaptive link system 100 located on the server(s) 804, in some implementations, the adaptive link system 100 may be implemented by (e.g., located entirely on or in part on) one or more other components of the environment. For example, the adaptive link system 100 may be implemented by the client device 808 and/or a third-party device. For example, the client device 808 can download all or part of the adaptive link system 100 for implementation independent of, or together with, the server(s) 804 and/or third-party server(s) 816. Moreover, in some implementations, the adaptive link system 100 may solely generate adaptive function links and utilize the adaptive function links to generate modified versions of content items.

In some implementations, though not illustrated in FIG. 8, the environment may have a different arrangement of components and/or may have a different number or set of components altogether. For example, the client device 808 may communicate directly with the adaptive link system 100, bypassing the network 812. As another example, the environment can include a database located external to the server(s) 804 (e.g., in communication via the network 812) or located on the server(s), on a third-party system, and/or on the client device 808.

As mentioned above, the adaptive link system 100 can generate an adaptive function link responsive to a request to generate a link for a content item. Additionally, the adaptive link system 100 can utilize the adaptive function link to generate a modified version of a content item (such as, for example, a redacted version of a content item and/or a translated version of a content item. Specifically the adaptive link system 100 can embed a computer function (such as a redaction function and/or a translation function) in a link script of the adaptive function link, and can execute the computer function to generate the modified version of the content item.

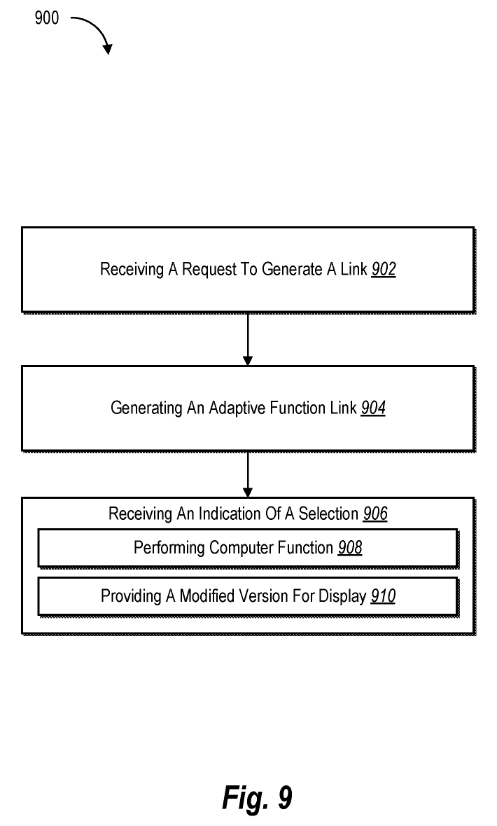

FIGS. 1-8, the corresponding text, and the examples provide a number of different systems and methods for generating an adaptive function link for a modified version of a content item. In addition to the foregoing, implementations can also be described in terms of flowcharts comprising acts or steps in a method for accomplishing a particular result. For example, FIG. 9 illustrates an example series of acts for generating an adaptive function link and utilizing the adaptive function link to provide a modified version of a content item to a client device in accordance with one or more embodiments.

While FIG. 9 illustrates acts according to certain implementations, alternative implementations may omit, add to, reorder and/or modify any of the acts shown in FIG. 9. The acts of FIG. 9 can be performed as part of a computer-implemented method. Alternatively, a non-transitory computer readable medium can comprise instructions, that when executed by one or more processors, cause a computing device to perform the acts of FIG. 9. In still further implementations, a system can perform the acts of FIG. 9.

As illustrated in FIG. 9, the series of acts 900 may include an act 902 of receiving a request to generate a link. In particular, the act 902 can include receiving a request to generate a link for a content item, wherein the request specifies a computer function to execute based on selection of the link. In addition, the series of acts 900 can include an act 904 of generating an adaptive function. In particular, the act 904 can include, in response to the request, generating an adaptive function link for the content item by embedding the computer function within a link script of the adaptive function link. Further, the series of acts 900 can include an act 906 of receiving an indication of a selection of the adaptive function link. In particular, the act 906 can include, in response to receiving an indication of a selection of the adaptive function link, an act 908 of performing a computer function. Specifically, the act 908 can include performing the computer function embedded in the link script to generate a modified version of the content item. Moreover, the act 906 can include, in response to receiving an indication of a selection of the adaptive function link, an act 910 of providing a modified version of the content item for display on a client device.

Additionally, in some embodiments, the series of acts 900 can include performing the computer function embedded in the link script by parsing the link script to determine a large language model instantiated by the adaptive function link and utilizing the large language model to generate the modified version of the content item.

Moreover, in one or more embodiments, the series of acts 900 can include receiving a second request to share the content item with a second client device, wherein the second request indicates a second computer function for modifying the content item upon sharing with the second client device. In addition, the series of acts 900 can include, in response to the second request, generating a second adaptive function link for the content item by embedding the computer function within a second link script of a second adaptive function link. Indeed, the series of acts 900 can include, in response to receiving, from the second client device, an indication of a selection of the second adaptive function link, performing the second computer function embedded in the second link script to generate a second modified version of the content item, and providing the second modified version of the content item for display on the second client device.

Additionally, in some embodiments, the series of acts 900 can include generating the adaptive function link by determining the computer function to embed within the link script according to link parameters defined by a requesting client device that provides the request to generate the link. Indeed, the series of acts can include generating the adaptive function link by generating an adapted version of the computer function to embed within the link script according to link augmentation parameters associated with a recipient client device. Moreover, the series of acts 900 can include providing the adapted version of the computer function to the recipient client device.

Additionally, in one or more embodiments, the series of acts 900 can include determining that the computer function is a redaction function. Moreover, the series of acts 900 can include performing the redaction function to generate a redacted version of the content item.

Further, in some embodiments, the series of acts 900 can include determining that the computer function is a translation function. In addition, the series of acts 900 can include performing the translation function to generate a translated version of the content item.

Indeed, in one or more embodiments, the series of acts 900 can include receiving a request to generate a link for a content item, wherein the request specifies a redaction function to execute based on selection of the link. Moreover, the series of acts 900 can include, in response to the request, generating an adaptive function link for the content item by embedding the redaction function within a link script of the adaptive function link. Further, the series of acts 900 can include, in response receiving an indication of a selection of the adaptive function link, performing the redaction function embedded in the link script to generate a redacted version of the content item, and providing the redacted version of the content item for display on a client device.

Moreover, in some embodiments, the series of acts 900 can include performing the redaction function embedded in the link script by parsing the link script to determine a redaction level to apply to the content item, and generating the redacted version of the content item by performing the redaction function according to the redaction level.

Furthermore, in one or more embodiments, the series of acts 900 can include receiving an upload of the content item to a content management system. Indeed, the series of acts 900 can include, in response to receiving the upload, generating a plurality of adaptive function links corresponding to respective redaction levels for the content item.

Additionally, in some embodiments, the series of acts 900 can include generating a preview of the redacted version of the content item for display in a user interface of a sender client device. Indeed, the series of acts 900 can include, based on receiving an indication of approval of the preview, generating the adaptive function link for the content item.

Moreover, in one or more embodiments, the series of acts 900 can include determining a plurality of redaction levels for the content item. Additionally, the series of acts 900 can include performing the redaction function embedded in the link script to generate a plurality of redacted versions of the content item according to the plurality of redaction levels. Furthermore, the series of acts 900 can include selecting the redacted version from the plurality of redacted versions according to a clearance level associated with the client device.

Additionally, in some embodiments, the series of acts 900 can include performing the redaction function embedded in the link script by determining a redaction level for the redaction function based on metadata associated with the client device, and generating the redacted version of the content item by redacting content according to the redaction level.

Further, in one or more embodiments, the series of acts 900 can include detecting an updated version of the content item. Additionally, the series of acts 900 can include updating the adaptive function link to reference the updated version of the content item.

Indeed, in one or more embodiments, the series of acts 900 can include receiving a request to generate a link for a content item, wherein the request specifies a translation function to execute based on selection of the link. Furthermore, the series of acts 900 can include, in response to the request, generating an adaptive function link for the content item by embedding the translation function within a link script of the adaptive function link. Indeed, the series of acts 900 can include, in response to receiving an indication of a selection of the adaptive function link, performing the translation function embedded in the link script to generate a translated version of the content item; and providing the translated version of the content item for display on a client device.

Moreover, in some embodiments, the series of acts 900 can include causing the performing the translation function embedded in the link script by parsing the link script to determine a translation language to apply to the content item, and generating the translated version of the content item by performing the translation function according to the translation language.

Indeed, in one or more embodiments, the series of acts 900 can include determining translation language to apply to the content item based on metadata associated with the client device.

Moreover, in some embodiments, the series of acts 900 can include generating a preview of the translated version of the content item for display in a user interface of a sender client device. Further, the series of acts 900 can include requesting an indication of approval for the translated version of the content item through the user interface of the sender client device.

Additionally, in some embodiments, the series of acts 900 can include receiving, from the client device, an indication of a request for a modified translation function to translate to a different language. Indeed, the series of acts 900 can include, based on the indication of the request for the modified translation function, updating the adaptive function link by embedding the modified translation function within the link script.

Further, in one or more embodiments, the series of acts 900 can include providing the translated version of the content item for display as an overlay layer modifying an appearance of the content item to reflect translated content.

Indeed, in some embodiments, the series of acts 900 can include determining a translation language for the translation function based on user account data for a user account associated with the client device.

The components of the adaptive link system 100 can include software, hardware, or both. For example, the components of the adaptive link system 100 can include one or more instructions stored on a computer-readable storage medium executable by processors of one or more computing devices. When executed by one or more processors, the computer-executable instructions of the adaptive link system 100 can cause a computing device to perform the methods described herein. Alternatively, the components of the adaptive link system 100 can comprise hardware, such as a special processing device to perform a certain function or group of functions. Additionally or alternatively, the components of the adaptive link system 100 can include a combination of computer-executable instructions and hardware.

Furthermore, the components of the adaptive link system 100 performing the functions described herein may, for example, be implemented as part of a stand-alone application, as a module of an application, as a plug-in for applications including content management applications, as a library function or functions that may be called by other applications, and/or as a cloud-computing model. Thus, the components of the adaptive link system 100 may be implemented as part of a stand-alone application on a personal computing device or a mobile device.

Embodiments of the present disclosure may comprise or utilize a special purpose or general-purpose computer including computer hardware, such as, for example, one or more processors and system memory, as discussed in greater detail below. Implementations within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, implementations of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some implementations, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Implementations of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 10 illustrates a block diagram of exemplary computing device 1000 (e.g., the server(s) 804 and/or the client device 808) that may be configured to perform one or more of the processes described above. One will appreciate that server(s) 804 and/or the client device 808 may comprise one or more computing devices such as computing device 1000. As shown by FIG. 10, computing device 1000 can comprise processor 1002, memory 1004, storage device 1006, I/O interface 1008, and communication interface 1010, which may be communicatively coupled by way of communication infrastructure 1012. While an exemplary computing device 1000 is shown in FIG. 10, the components illustrated in FIG. 10 are not intended to be limiting. Additional or alternative components may be used in other implementations. Furthermore, in certain implementations, computing device 1000 can include fewer components than those shown in FIG. 10. Components of computing device 1000 shown in FIG. 10 will now be described in additional detail.

In particular implementations, processor 1002 includes hardware for executing instructions, such as those making up a computer program. As an example and not by way of limitation, to execute instructions, processor 1002 may retrieve (or fetch) the instructions from an internal register, an internal cache, memory 1004, or storage device 1006 and decode and execute them. In particular implementations, processor 1002 may include one or more internal caches for data, instructions, or addresses. As an example and not by way of limitation, processor 1002 may include one or more instruction caches, one or more data caches, and one or more translation lookaside buffers (TLBs). Instructions in the instruction caches may be copies of instructions in memory 1004 or storage device 1006.

Memory 1004 may be used for storing data, metadata, and programs for execution by the processor(s). Memory 1004 may include one or more of volatile and non-volatile memories, such as Random Access Memory (“RAM”), Read Only Memory (“ROM”), a solid state disk (“SSD”), Flash, Phase Change Memory (“PCM”), or other types of data storage. Memory 1004 may be internal or distributed memory.

Storage device 1006 includes storage for storing data or instructions. As an example and not by way of limitation, storage device 1006 can comprise a non-transitory storage medium described above. Storage device 1006 may include a hard disk drive (HDD), a floppy disk drive, flash memory, an optical disc, a magneto-optical disc, magnetic tape, or a Universal Serial Bus (USB) drive or a combination of two or more of these. Storage device 1006 may include removable or non-removable (or fixed) media, where appropriate. Storage device 1006 may be internal or external to computing device 1000. In particular implementations, storage device 1006 is non-volatile, solid-state memory. In other implementations, Storage device 1006 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

I/O interface 1008 allows a user to provide input to, receive output from, and otherwise transfer data to and receive data from computing device 1000. I/O interface 1008 may include a mouse, a keypad or a keyboard, a touch screen, a camera, an optical scanner, network interface, modem, other known I/O devices or a combination of such I/O interfaces. I/O interface 1008 may include one or more devices for presenting output to a user, including, but not limited to, a graphics engine, a display (e.g., a display screen), one or more output drivers (e.g., display drivers), one or more audio speakers, and one or more audio drivers. In certain implementations, I/O interface 1008 is configured to provide graphical data to a display for presentation to a user. The graphical data may be representative of one or more graphical user interfaces and/or any other graphical content as may serve a particular implementation.

Communication interface 1010 can include hardware, software, or both. In any event, communication interface 1010 can provide one or more interfaces for communication (such as, for example, packet-based communication) between computing device 1000 and one or more other computing devices or networks. As an example and not by way of limitation, communication interface 1010 may include a network interface controller (NIC) or network adapter for communicating with an Ethernet or other wire-based network or a wireless NIC (WNIC) or wireless adapter for communicating with a wireless network, such as a WI-FI.

Additionally or alternatively, communication interface 1010 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, communication interface 1010 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, communication interface 1010 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

Communication infrastructure 1012 may include hardware, software, or both that couples components of computing device 1000 to each other. As an example and not by way of limitation, communication infrastructure 1012 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

In the foregoing specification, the present disclosure has been described with reference to specific exemplary implementations thereof. Various implementations and aspects of the present disclosure(s) are described with reference to details discussed herein, and the accompanying drawings illustrate the various implementations. The description above and drawings are illustrative of the disclosure and are not to be construed as limiting the disclosure. Numerous specific details are described to provide a thorough understanding of various implementations of the present disclosure.

The present disclosure may be embodied in other specific forms without departing from its spirit or essential characteristics. The described implementations are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

The foregoing specification is described with reference to specific exemplary implementations thereof. Various implementations and aspects of the disclosure are described with reference to details discussed herein, and the accompanying drawings illustrate the various implementations. The description above and drawings are illustrative and are not to be construed as limiting. Numerous specific details are described to provide a thorough understanding of various implementations.

The additional or alternative implementations may be embodied in other specific forms without departing from its spirit or essential characteristics. The described implementations are to be considered in all respects only as illustrative and not restrictive. The scope of the invention is, therefore, indicated by the appended claims rather than by the foregoing description. All changes that come within the meaning and range of equivalency of the claims are to be embraced within their scope.

FIG. 11 is a schematic diagram illustrating environment 1100 within which one or more implementations of the adaptive link system 100 can be implemented. For example, the adaptive link system 100 may be part of a content management system 1102 (e.g., the content management system 1102). Content management system 1102 may generate, store, manage, receive, and send digital content (such as digital content items). For example, content management system 1102 may send and receive digital content to and from client devices 1106 by way of network 1104. In particular, content management system 1102 can store and manage a collection of digital content. Content management system 1102 can manage the sharing of digital content between computing devices associated with a plurality of users. For instance, content management system 1102 can facilitate a user sharing a digital content with another user of content management system 1102.

In particular, content management system 1102 can manage synchronizing digital content across multiple client devices 1106 associated with one or more users. For example, a user may edit digital content using client device 1106. The content management system 1102 can cause client device 1106 to send the edited digital content to content management system 1102. Content management system 1102 then synchronizes the edited digital content on one or more additional computing devices.

In addition to synchronizing digital content across multiple devices, one or more implementations of content management system 1102 can provide an efficient storage option for users that have large collections of digital content. For example, content management system 1102 can store a collection of digital content on content management system 1102, while the client device 1106 only stores reduced-sized versions of the digital content. A user can navigate and browse the reduced-sized versions (e.g., a thumbnail of a digital image) of the digital content on client device 1106. In particular, one way in which a user can experience digital content is to browse the reduced-sized versions of the digital content on client device 1106.

Another way in which a user can experience digital content is to select a reduced-size version of digital content to request the full- or high-resolution version of digital content from content management system 1102. In particular, upon a user selecting a reduced-sized version of digital content, client device 1106 sends a request to content management system 1102 requesting the digital content associated with the reduced-sized version of the digital content. Content management system 1102 can respond to the request by sending the digital content to client device 1106. Client device 1106, upon receiving the digital content, can then present the digital content to the user. In this way, a user can have access to large collections of digital content while minimizing the amount of resources used on client device 1106.

Client device 1106 may be a desktop computer, a laptop computer, a tablet computer, a personal digital assistant (PDA), an in- or out-of-car navigation system, a handheld device, a smart phone or other cellular or mobile phone, or a mobile gaming device, other mobile device, or other suitable computing devices. Client device 1106 may execute one or more client applications, such as a web browser (e.g., Microsoft Windows Internet Explorer, Mozilla Firefox, Apple Safari, Google Chrome, Opera, etc.) or a native or special-purpose client application (e.g., Dropbox Paper for iPhone or iPad, Dropbox Paper for Android, etc.), to access and view content over network 1104.

Network 1104 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which client devices 1106 may access content management system 1102.

In the foregoing specification, the present disclosure has been described with reference to specific exemplary implementations thereof. Various implementations and aspects of the present disclosure(s) are described with reference to details discussed herein, and the accompanying drawings illustrate the various implementations. The description above and drawings are illustrative of the disclosure and are not to be construed as limiting the disclosure. Numerous specific details are described to provide a thorough understanding of various implementations of the present disclosure.

The present disclosure may be embodied in other specific forms without departing from its spirit or essential characteristics. The described implementations are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

The foregoing specification is described with reference to specific exemplary implementations thereof. Various implementations and aspects of the disclosure are described with reference to details discussed herein, and the accompanying drawings illustrate the various implementations. The description above and drawings are illustrative and are not to be construed as limiting. Numerous specific details are described to provide a thorough understanding of various implementations.

The additional or alternative implementations may be embodied in other specific forms without departing from its spirit or essential characteristics. The described implementations are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
receiving a request to generate a link for a content item, wherein the request specifies a computer function to execute based on selection of the link;
in response to the request, generating an adaptive function link for the content item by embedding the computer function within a link script of the adaptive function link; and
in response to receiving an indication of a selection of the adaptive function link:
performing the computer function embedded in the link script to generate a modified version of the content item; and
providing the modified version of the content item for display on a client device.

2. The computer-implemented method of claim 1, wherein performing the computer function embedded in the link script comprises:
parsing the link script to determine a large language model instantiated by the adaptive function link; and
utilizing the large language model to generate the modified version of the content item.

3. The computer-implemented method of claim 1, wherein generating the adaptive function link comprises determining the computer function to embed within the link script according to link parameters defined by a requesting client device that provides the request to generate the link.

4. The computer-implemented method of claim 1, wherein generating the adaptive function link comprises generating an adapted version of the computer function to embed within the link script according to link augmentation parameters associated with a recipient client device and providing the adapted version of the computer function to the client device.

5. The computer-implemented method of claim 1, further comprising:
determining that the computer function is a redaction function; and
performing the redaction function to generate a redacted version of the content item.

6. The computer-implemented method of claim 1, further comprising:
determining that the computer function is a translation function; and
performing the translation function to generate a translated version of the content item.

7. A system comprising:
at least one processor; and
at least one non-transitory computer readable storage medium storing instructions that, when executed by the at least one processor, cause the system to:
receive a request to generate a link for a content item, wherein the request specifies a redaction function to execute based on selection of the link;
in response to the request, generate an adaptive function link for the content item by embedding the redaction function within a link script of the adaptive function link; and
in response receiving an indication of a selection of the adaptive function link:
perform the redaction function embedded in the link script to generate a redacted version of the content item; and
provide the redacted version of the content item for display on a client device.

8. The system of claim 7, further comprising instructions that, when executed by the at least one processor, cause the system to perform the redaction function embedded in the link script by:
parsing the link script to determine a redaction level to apply to the content item; and
generating the redacted version of the content item by performing the redaction function according to the redaction level.

9. The system of claim 7, further comprising instructions that, when executed by the at least one processor, cause the system to:
receive an upload of the content item to a content management system; and
in response to receiving the upload, generating a plurality of adaptive function links corresponding to respective redaction levels for the content item.

10. The system of claim 7, further comprising instructions that, when executed by the at least one processor, cause the system to:
generate a preview of the redacted version of the content item for display in a user interface of a sender client device; and
based on receiving an indication of approval of the preview, generating the adaptive function link for the content item.

11. The system of claim 7, further comprising instructions that, when executed by the at least one processor, cause the system to:
determine a plurality of redaction levels for the content item;
perform the redaction function embedded in the link script to generate a plurality of redacted versions of the content item according to the plurality of redaction levels; and
select the redacted version from the plurality of redacted versions according to a clearance level associated with the client device.

12. The system of claim 7, further comprising instructions that, when executed by the at least one processor, cause the system to perform the redaction function embedded in the link script by:
determining a redaction level for the redaction function based on metadata associated with the client device; and
generating the redacted version of the content item by redacting content according to the redaction level.

13. The system of claim 7, further comprising instructions that, when executed by the at least one processor, cause the system to:
detect an updated version of the content item; and
update the adaptive function link to reference the updated version of the content item.

14. A non-transitory computer-readable medium storing instructions thereon that, when executed by at least one processor, cause a computing device to:
receive a request to generate a link for a content item, wherein the request specifies a translation function to execute based on selection of the link;
in response to the request, generating an adaptive function link for the content item by embedding the translation function within a link script of the adaptive function link; and
in response to receiving an indication of a selection of the adaptive function link:
performing the translation function embedded in the link script to generate a translated version of the content item; and
providing the translated version of the content item for display on a client device.

15. The non-transitory computer-readable medium of claim 14, further comprising instructions that, when executed by the at least one processor, cause the computing device to perform the translation function embedded in the link script by:
parsing the link script to determine a translation language to apply to the content item; and
generating the translated version of the content item by performing the translation function according to the translation language.

16. The non-transitory computer-readable medium of claim 15, further comprising instructions that, when executed by the at least one processor, cause the computing device to determine the translation language to apply to the content item based on metadata associated with the client device.

17. The non-transitory computer-readable medium of claim 14, further comprising instructions that, when executed by the at least one processor, cause the computing device to:
generate a preview of the translated version of the content item for display in a user interface of a requester client device; and
request an indication of approval for the translated version of the content item through the user interface of the requester client device.

18. The non-transitory computer-readable medium of claim 14, further comprising instructions that, when executed by the at least one processor, cause the computing device to:
receive, from the client device, an indication of a request for a modified translation function to translate the content item to a different language; and
based on the indication of the request for the modified translation function, updating the adaptive function link by embedding the modified translation function within the link script.

19. The non-transitory computer-readable medium of claim 14, further comprising instructions that, when executed by the at least one processor, cause the computing device to provide the translated version of the content item for display as an overlay layer modifying an appearance of the content item to reflect translated content.

20. The non-transitory computer-readable medium of claim 14, further comprising instructions that, when executed by the at least one processor, cause the computing device to determine a translation language for the translation function based on user account data for a user account associated with the client device.
